(19) United States
(12) Patent Application Publication
(10) Pub. No.: US 2024/0414522 A1
(43) Pub. Date: Dec. 12, 2024

(54) COMPUTING POWER CAPABILITY SENSING METHOD AND APPARATUS

(71) Applicant: HUAWEI TECHNOLOGIES CO., LTD., Shenzhen (CN)

(72) Inventors: Zhe LIU, Shanghai (CN); Chenghui PENG, Shanghai (CN); Jianjun WU, Shenzhen (CN)

(21) Appl. No.: 18/808,417

(22) Filed: Aug. 19, 2024

Related U.S. Application Data
(63) Continuation of application No. PCT/CN2023/073043, filed on Jan. 19, 2023.

(30) Foreign Application Priority Data
Feb. 21, 2022 (CN) 202210157890.1

(51) Int. Cl. H04W 8/22; H04W 24/02; H04W 80/02

(52) U.S. Cl. CPC H04W 8/22; H04W 24/02; H04W 80/02

(57) ABSTRACT

A method comprises: a first device obtains, by receiving first signaling, a type and/or a granularity of a computing power capability that needs to be reported, so that a control plane in a network may subsequently perform dynamic computing power scheduling and adjust a computing power scheduling policy, based on the computing power capability reported by the first device, to improve efficiency of sensing the computing power capability by the network and efficiency of configuring computing power.

### CROSS-REFERENCE TO RELATED APPLICATIONS

This application is a continuation of International Application No. PCT/CN2023/073043, filed on Jan. 19, 2023, which claims priority to Chinese Patent Application No. 202210157890.1, filed on Feb. 21, 2022. The disclosures of the aforementioned applications are hereby incorporated by reference in their entireties.

### TECHNICAL FIELD

Embodiments of this disclosure relate to the field of wireless communication, and more particularly, to a computing power capability sensing method and apparatus.

### BACKGROUND

In a new computing power network architecture, each network element not only has control and forwarding capabilities, but also has a computing capability. In addition to the network element, a computing node is further deployed on a network. Computing power generated in such a computing-network integration mode is referred to as network native computing power. Although the computing capability is also introduced in a current 5G architecture, a focus is on downward deployment of the computing capability. For example, in a mobile/multi-access edge computing (MEC) solution in the 5G architecture, a user plane function (UPF) network element in a core network may be co-located with the MEC, and the MEC and the UPF may be downward deployed in a base station and be co-located with the base station.

However, in the 5G architecture, a control part and a computing part in the network are still relatively loosely coupled. It may also be understood as that the network in the 5G architecture does not have a capability of the native computing power. This is because in the 5G architecture, service deployment on the computing power is implemented through a management plane and is not dynamic. In other words, user movement and a network change cannot be responded in time. Therefore, when a computing power capability of a terminal device or a network device changes and a computing power configuration needs to be adjusted, or when a computing power configuration changes and a computing power capability needs to be adjusted, a control plane in the network usually cannot respond in time, resulting in a long adjustment delay (for example, generating a minute-level adjustment delay).

In view of this, in the current 5G architecture, how to improve efficiency of sensing the computing power capability of the terminal device or the network device by the control plane becomes a technical problem that needs to be resolved.

### SUMMARY

Embodiments of this disclosure provide a computing power capability sensing method and apparatus. A first device obtains, by receiving first signaling, a type and/or a granularity of a computing power capability that needs to be reported, so that a control plane (for example, a base station or a computing management control function (CMF) network element) in a network may subsequently perform dynamic computing power scheduling, adjust a computing power scheduling policy, and so on, based on the computing power capability reported by the first device, to improve efficiency of sensing the computing power capability by the network and efficiency of configuring computing power.

According to a first aspect, a computing power capability sensing method is provided. The method may be performed by a terminal device, or may be performed by a component (for example, a chip or a circuit) of a terminal device. This is not limited. Alternatively, the method may be performed by a radio access network device (for example, a base station or a CMF network element), or may be performed by a component (for example, a chip or a circuit) of a radio access network device. This is not limited.

The method includes: A first device receives first signaling from a second device, where the first signaling indicates a type of a computing power capability reported by the first device and/or a granularity of the reported computing power capability. The first device reports the computing power capability to the second device based on the first signaling.

It should be noted that, in this disclosure, the first device may be, for example, a terminal device (for example, a UE). For another example, the first device may be a radio access network device (for example, a base station). The second device may be, for example, a radio access network device. For another example, the second device may be a CMF network element. For example, when the first device is the UE, the second device may be, for example, the base station. When the first device is the base station, the second device may be, for example, the CMF.

It should be understood that the “signaling” in this disclosure may be control information or higher layer signaling. For example, the control information may be downlink control information (DCI) or uplink control information (UCI). For example, the higher layer signaling may be radio resource control (RRC) signaling or media access control-control element (MAC CE) signaling. Types of different signaling may be the same or may be different. For example, the signaling may be the DCI or the UCI, or may be the RRC signaling, a system information block (SIB), or the MAC CE signaling. This is not limited in this disclosure.

In this disclosure, the first device reports the computing power capability to the second device based on the first signaling. For example, the first device may report the computing power capability based on the type that is of the reported computing power capability and that is indicated by the first signaling. For another example, the first device may report the computing power capability based on the granularity that is of the reported computing power capability and that is indicated by the first signaling.

In one embodiment, the type of the computing power capability reported by the first device includes at least one of the following: a processor of the first device, storage space of the first device, a memory of the first device, or a state of charge of the first device.

For example, a type of a computing power capability of the processor of the first device may be a computing power capability of a central processing unit (CPU), a computing power capability of a graphic processing unit (GPU), a computing power capability of a tensor processing unit (TPU), a computing power capability of a neural network processing unit (NPU), a field programmable gate array (FPGA), or the like. This is not limited. In one embodiment, the computing power capability of the processor may also be understood as a logical computing power capability of the processor, a parallel computing power capability of the processor, or a dedicated computing capability of the processor. For another example, the parallel computing power capability of the processor may include a frequency of the CPU, a quantity of CPU cores, a quantity of times of multiplication and addition calculation supported by the CPU per second, a quantity of times of dot multiplication of the CPU, a quantity of times of convolution of the CPU, a quantity of times of floating-point calculation of the CPU, a quantity of operations, and the like.

Based on the foregoing technical solution, in this disclosure, the first signaling may be sent to prevent the first device whose type of the computing power capability does not satisfy a requirement of a network device from reporting terminal computing power, thereby reducing invalid reporting and a waste of bandwidth resources.

In one embodiment, the granularity of the computing power capability reported by the first device includes at least one of the following: a granularity of the processor reported by the first device, a granularity of the storage space reported by the first device, a granularity of the memory reported by the first device, or a granularity of the state of charge reported by the first device.

For example, in this disclosure, the granularity of the processor reported by the first device may be X, the granularity of the storage space reported by the first device is Y MB, the granularity of the memory reported by the first device is W MB, and the granularity of the state of charge reported by the first device is Z %, where X, Y, W, and Z are all integers greater than 0.

Based on the foregoing technical solution, in this disclosure, the first device whose computing power capability is less than a scheduling granularity of the network device may be prevented from reporting the computing power capability, thereby reducing computing power reporting overheads.

In one embodiment, the first device may report the computing power capability to the second device by using layer 1 (L1) signaling, layer 2 (L2) signaling, or layer 3 (L3) signaling.

In one embodiment, the method further includes: The first device receives second signaling from the second device, where the second signaling includes identification information, the identification information identifies a computing power resource, the second signaling indicates the first device to report a usage status of the computing power resource, and the computing power resource is a resource corresponding to the computing power capability of the first device. The first device sends third signaling to the second device, where the third signaling includes information about the usage status of the computing power resource.

In this disclosure, the identification information may include, for example, identification information of resource configuration and/or index information of the resource configuration.

In this disclosure, the usage status of the computing power resource includes at least one of the following: a utilization ratio of the computing power resource, the computing power resource being idle, and the computing power resource being occupied.

Based on the foregoing technical solution, in this disclosure, the first device reports the usage status of the computing power resource by receiving the second signaling, so that a control plane (for example, a base station or a CMF network element) in a network may subsequently perform dynamic computing power scheduling, adjust a computing power scheduling policy, and so on based on the usage status of the computing power resource reported by the first device, to improve efficiency of configuring network computing power.

In one embodiment, that the first device sends third signaling to the second device includes: The first device periodically sends the third signaling to the second device, or when the utilization ratio of the computing power resource exceeds a configured threshold, the first device sends the third signaling to the second device.

In one embodiment, the third signaling includes one or more of the following: the layer 1 (L1) signaling, the layer 2 (L2) signaling, the layer 3 (L3) signaling, a long media access control-control element signaling, or a short media access control-control element signaling.

Based on the foregoing technical solution, in this disclosure, the first device may send signaling to the second device, so that the second device may learn of the computing power capability of the first device in time, or learn of the usage status of the computing power resource of the first device in time, to improve efficiency of configuring the network computing power.

According to a second aspect, a computing power capability sensing method is provided. The method may be performed by a terminal device, or may be performed by a component (for example, a chip or a circuit) of a terminal device. This is not limited. Alternatively, the method may be performed by a radio access network device (for example, a base station or a CMF network element), or may be performed by a component (for example, a chip or a circuit) of a radio access network device. This is not limited.

The method includes: A first device receives second signaling from a second device, where the second signaling includes identification information, the identification information identifies a computing power resource, the second signaling indicates the first device to report a usage status of the computing power resource, the computing power resource is a resource corresponding to a computing power capability of the first device, and the computing power capability includes a type of the computing power capability and/or a granularity of the computing power capability. The first device sends third signaling to the second device, where the third signaling includes information about the usage status of the computing power resource.

In this disclosure, the identification information may include identification information of resource configuration and/or index information of the resource configuration.

In this disclosure, the usage status of the computing power resource includes at least one of the following: a utilization ratio of the computing power resource, the computing power resource being idle, and the computing power resource being occupied.

Based on the foregoing technical solution, in this disclosure, the first device reports the usage status of the computing power resource by receiving the second signaling, so that a control plane in a network may subsequently perform dynamic computing power scheduling, adjust a computing power scheduling policy, and so on based on the usage status of the computing power resource reported by the first device, to improve efficiency of configuring network computing power.

In one embodiment, before that a first device receives second signaling from a second device, the method further includes: The first device receives first signaling from the second device, where the first signaling indicates the computing power capability reported by the first device. The first device reports the computing power capability based on the first signaling.

In one embodiment, the first signaling indicates a type of the computing power capability reported by the first device and/or a granularity of the reported computing power capability.

Based on the foregoing technical solution, in this disclosure, the first device obtains, by receiving the first signaling, the type and/or the granularity of the computing power capability that needs to be reported, so that the control plane (for example, a base station or a computing management control function (CMF) network element) in the network may subsequently perform dynamic computing power scheduling, adjust a computing power scheduling policy, and so on, based on the computing power capability reported by the first device, to improve the efficiency of sensing the computing power capability by the network and efficiency of configuring the computing power.

In one embodiment, the type of the computing power capability includes at least one of the following: a processor of the first device, storage space of the first device, a memory of the first device, or a state of charge of the first device.

Based on the foregoing technical solution, in this disclosure, the first signaling may be sent to prevent the first device whose type of the computing power capability does not satisfy a requirement of a network device from reporting terminal computing power, thereby reducing invalid reporting and a waste of bandwidth resources.

In one embodiment, the granularity of the computing power capability reported by the first device includes at least one of the following: a granularity of the processor of the first device, a granularity of the storage space of the first device, a granularity of the memory of the first device, or a granularity of the state of charge of the first device.

Based on the foregoing technical solution, in this disclosure, the first device whose computing power capability is less than a scheduling granularity of the network device may be prevented from reporting the computing power capability, thereby reducing computing power reporting overheads.

In one embodiment, that the first device sends third signaling to the second device includes: The first device periodically sends the third signaling to the second device, or when the utilization ratio of the computing power resource exceeds a configured threshold, the first device sends the third signaling to the second device.

In one embodiment, the third signaling includes one or more of the following: layer 1 (L1) signaling, layer 2 (L2) signaling, layer 3 (L3) signaling, long media access control-control element signaling, or short media access control-control element signaling.

According to a third aspect, a computing power capability sensing method is provided. The method may be performed by a radio access network device, or may be performed by a component (for example, a chip or a circuit) of a radio access network device. This is not limited. Alternatively, the method may be performed by a CMF network element, or may be performed by a component (for example, a chip or a circuit) of a CMF network element. This is not limited.

The method includes: A second device sends first signaling to a first device, where the first signaling indicates a type of a computing power capability reported by the first device and/or a granularity of the reported computing power capability. The second device receives the computing power capability reported by the first device.

Based on the foregoing technical solution, in this disclosure, a network device may send the first signaling to the first device, to indicate the type and/or the granularity of the computing power capability that needs to be reported by the first device, so that a control plane (for example, a base station or a CMF) in a network may subsequently perform dynamic computing power scheduling, adjust a computing power scheduling policy, and so on, based on the computing power capability reported by the first device, to improve efficiency of sensing the computing power capability by the network and efficiency of configuring network computing power.

In one embodiment, the type of the computing power capability reported by the first device includes at least one of the following: a processor of the first device, storage space of the first device, a memory of the first device, or a state of charge of the first device.

In one embodiment, the granularity of the computing power capability reported by the first device includes at least one of the following: a granularity of the processor of the first device, a granularity of the storage space of the first device, a granularity of the memory of the first device, or a granularity of the state of charge of the first device.

In one embodiment, the method further includes: The second device sends second signaling to the first device, where the second signaling includes identification information, the identification information identifies a computing power resource, the second signaling indicates a usage status of the computing power resource reported by the first device, and the computing power resource is a resource corresponding to the computing power capability of the first device. The second device receives third signaling from the first device, where the third signaling includes information about the usage status of the computing power resource.

Based on the foregoing technical solution, in this disclosure, the network device sends the second signaling to the first device, to indicate the first device to report the usage status of the computing power resource, so that the control plane in the network may subsequently perform dynamic computing power scheduling, adjust a computing power scheduling policy, and so on based on the usage status of the computing power resource reported by the first device, to improve efficiency of configuring network computing power.

In one embodiment, the identification information includes identification information of resource configuration and/or index information of the resource configuration.

In one embodiment, the usage status of the computing power resource includes at least one of the following: a utilization ratio of the computing power resource, the computing power resource being idle, and the computing power resource being occupied.

In one embodiment, that the second device receives third signaling from the first device includes: The second device periodically receives the third signaling from the first device, or when the utilization ratio of the computing power resource exceeds a configured threshold, the second device receives the third signaling from the first device.

In one embodiment, the third signaling includes one or more of the following: layer 1 (L1) signaling, layer 2 (L2) signaling, layer 3 (L3) signaling, a long media access control-control element signaling, or a short media access control-control element signaling.

According to a fourth aspect, a computing power capability sensing method is provided. The method may be performed by a radio access network device, or may be performed by a component (for example, a chip or a circuit) of a radio access network device. This is not limited. Alternatively, the method may be performed by a CMF network element, or may be performed by a component (for example, a chip or a circuit) of a CMF network element. This is not limited.

The method includes: A second device sends second signaling to a second device, where the second signaling includes identification information, the identification information identifies a computing power resource, the second signaling indicates the first device to report a usage status of the computing power resource, and the computing power resource is a resource corresponding to a computing power capability of the first device. The second device receives third signaling from the first device, where the third signaling includes information about the usage status of the computing power resource.

In this disclosure, the usage status of the computing power resource includes at least one of the following: a utilization ratio of the computing power resource, the computing power resource being idle, and the computing power resource being occupied.

In this disclosure, the identification information may include identification information of resource configuration and/or index information of the resource configuration.

Based on the foregoing technical solution, in this disclosure, a network device sends the second signaling to the first device, to indicate the first device to report the usage status of the computing power resource, so that a control plane in a network may subsequently perform dynamic computing power scheduling, adjust a computing power scheduling policy, and so on based on the usage status of the computing power resource reported by the first device, to improve efficiency of configuring network computing power.

In one embodiment, before that a second device sends second signaling to a first device, the method further includes: The first device receives first signaling from the second device, where the first signaling indicates the computing power capability reported by the first device. The first device reports the computing power capability based on the first signaling.

In one embodiment, the first signaling indicates a type of the computing power capability reported by the first device and/or a granularity of the reported computing power capability.

Based on the foregoing technical solution, the network device may send the first signaling to the first device, to indicate the type and/or the granularity of the computing power capability that needs to be reported by the first device, so that the control plane (for example, a base station or a CMF) in the network may subsequently perform dynamic computing power scheduling, adjust a computing power scheduling policy, and so on, based on the computing power capability reported by the first device, to improve efficiency of sensing the computing power capability by the network and efficiency of configuring network computing power.

In one embodiment, the type of the computing power capability includes at least one of the following: a processor of the first device, storage space of the first device, a memory of the first device, or a state of charge of the first device.

In one embodiment, the granularity of the computing power capability reported by the first device includes at least one of the following: a granularity of the processor of the first device, a granularity of the storage space of the first device, a granularity of the memory of the first device, or a granularity of the state of charge of the first device.

In one embodiment, that the first device sends third signaling to the second device includes: The first device periodically sends the third signaling to the second device, or when the utilization ratio of the computing power resource exceeds a configured threshold, the first device sends the third signaling to the second device.

In one embodiment, the third signaling includes at least one or more of the following: layer 1 (L1) signaling, layer 2 (L2) signaling, layer 3 (L3) signaling, long media access control-control element signaling, or short media access control-control element signaling.

According to a fifth aspect, a computing power capability sensing apparatus is provided. For beneficial effects, refer to descriptions of the first aspect and the second aspect. Details are not described herein again. The communication apparatus has functions of implementing behavior in the method instances in the first aspect and the second aspect. The functions may be implemented by hardware, or may be implemented by hardware executing corresponding software. The hardware or the software includes one or more units/modules corresponding to the functions. In one embodiment, the communication apparatus includes a transceiver unit and a processing unit. These modules may perform corresponding functions in the method examples in the first aspect and the second aspect. For details, refer to the detailed descriptions in the method examples. Details are not described herein again.

According to a sixth aspect, a computing power capability sensing apparatus is provided. For beneficial effects, refer to descriptions of the third aspect and the fourth aspect. Details are not described herein again. The communication apparatus has functions of implementing behavior in the method instances in the third aspect and the fourth aspect. The functions may be implemented by hardware, or may be implemented by hardware executing corresponding software. The hardware or the software includes one or more units/modules corresponding to the functions. In one embodiment, the communication apparatus includes a transceiver unit and a processing unit. These modules may perform corresponding functions in the method examples in the third aspect and the fourth aspect. For details, refer to the detailed descriptions in the method examples. Details are not described herein again.

According to a seventh aspect, a computing power capability sensing apparatus is provided. The communication apparatus may be the terminal device or the radio access network device in the foregoing method embodiments, or may be a chip disposed in the terminal device or the radio access network device. The communication apparatus includes a communication interface and a processor, and optionally, further includes a storage. The storage is configured to store a computer program or instructions. The processor is coupled to the storage and the communication interface. When the processor executes the computer program or the instructions, the communication apparatus is enabled to perform the method performed by the terminal device in the foregoing method embodiments.

According to an eighth aspect, a computing power capability sensing apparatus is provided. The communication apparatus may be the network device in the foregoing method embodiments, or may be a chip disposed in the network device. The communication apparatus includes a communication interface and a processor, and optionally, further includes a storage. The storage is configured to store a computer program or instructions. The processor is coupled to the storage and the communication interface. When the processor executes the computer program or the instructions, the communication apparatus is enabled to perform the method performed by the network device in the foregoing method embodiments.

According to a ninth aspect, a computer program product is provided. The computer program product includes computer program code. When the computer program code is run, the method performed by the terminal device or the radio access network device in the foregoing aspects is performed.

According to a tenth aspect, a computer program product is provided. The computer program product includes computer program code. When the computer program code is run, the method performed by the network device in the foregoing aspects is performed.

According to an eleventh aspect, this disclosure provides a chip system. The chip system includes a processor, configured to implement functions of the terminal device or the radio access network device in the methods in the foregoing aspects. In one embodiment, the chip system further includes a storage, configured to store program instructions and/or data. The chip system may include a chip, or may include a chip and another discrete component.

According to a twelfth aspect, this disclosure provides a chip system. The chip system includes a processor, configured to implement functions of the network device in the methods in the foregoing aspects. In one embodiment, the chip system further includes a storage, configured to store program instructions and/or data. The chip system may include a chip, or may include a chip and another discrete component.

According to a thirteenth aspect, this disclosure provides a computer-readable storage medium. The computer-readable storage medium stores a computer program. When the computer program is run, the method performed by the terminal device or the radio access network device in the foregoing aspects is performed.

According to a fourteenth aspect, this disclosure provides a computer-readable storage medium. The computer-readable storage medium stores a computer program. When the computer program is run, the method performed by the network device in the foregoing aspects is performed.

### BRIEF DESCRIPTION OF DRAWINGS

FIG. 1 is a schematic of a system architecture to which this disclosure is applicable;

FIG. 2 is a schematic of a communication architecture to which this disclosure is applicable;

FIG. 3 is a schematic of a protocol stack architecture to which this disclosure is applicable;

FIG. 4 is a schematic flowchart of a computing power capability sensing method 400 according to this disclosure;

FIG. 5 is a schematic flowchart of a computing power capability sensing method 500 according to this disclosure;

FIG. 6 is a diagram of a structure of a computing power capability sensing apparatus 100 according to this disclosure; and

FIG. 7 is a diagram of a structure of a computing power capability sensing apparatus 200 according to this disclosure.

### DESCRIPTION OF EMBODIMENTS

The following describes technical solutions in embodiments of this disclosure with reference to the accompanying drawings.

A wireless communication system mentioned in this disclosure includes but is not limited to a global system for mobile communications (GSM), a long term evolution (LTE) frequency division duplex (FDD) system, an LTE time division duplex (TDD) system, an LTE system, a long term evolution-advanced (LTE-Advanced, LTE-A) system, a next-generation communication system (for example, a 6G communication system), a system integrating a plurality of access systems, or an evolved system.

The technical solutions provided in this disclosure may be further applied to machine type communication (MTC), long-term evolution machine type communication (LTE-M), a device-to-device (D2D) network, a machine-to-machine (M2M) network, an internet of things (IoT) network, or another network. The IoT network may include, for example, an internet of vehicles. A communication manner in an internet of vehicles system is collectively referred to as a vehicle to everything (vehicle to X, V2X, where X may represent anything). For example, the V2X may include: vehicle-to-vehicle (V2V) communication, vehicle-to-infrastructure (V2I) communication, vehicle-to-pedestrian (V2P) communication, vehicle-to-network (V2N) communication, or the like.

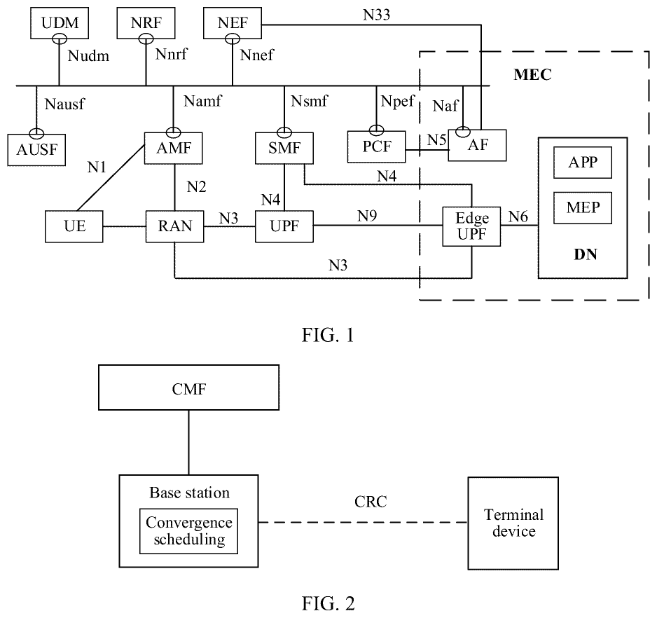

A network architecture applicable to this disclosure is first briefly described. For example, FIG. 1 is a schematic of a network architecture to which this disclosure is applicable.

As shown in FIG. 1, a 5G system (5th generation system, 5GS) is used as an example of the network architecture. The architecture of the 5G system is divided into two parts: an access network and a core network. The network architecture may include but is not limited to: unified data management (UDM), a network exposure function (NEF), a network repository function (NRF), a policy control function (PCF), an application function (AF), an access and mobility management function (AMF), a session management function (SMF), a user equipment (UE), a radio access network device, a user plane function (UPF), and a data network (DN). The DN may be the Internet. The UDM, the NEF, the NRF, the PCF, the AF, the AMF, the SMF, and the UPF are network elements in the core network. Because the 5G system is used as an example in FIG. 1, the core network may be referred to as a 5G core network (5GC or 5GCN). The following briefly describes network elements shown in FIG. 1.

1. A user equipment (UE) may be referred to as a terminal device, an access terminal, a subscriber unit, a subscriber station, a mobile station, a remote station, a remote terminal, a mobile device, a user terminal, a terminal, a wireless communication device, a user agent, or a user apparatus.

The terminal device may be a device that provides a user with voice/data, for example, a handheld device or an in-vehicle device having a wireless connection function. Currently, some examples of the terminals are: a mobile phone, a tablet computer, a notebook computer, a palmtop computer, a mobile internet device (MID), a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a terminal device in a 5G network, a terminal device in a future evolved public land mobile network (PLMN), or the like. This is not limited in embodiments of this disclosure.

By way of example but not limitation, in embodiments of this disclosure, the terminal device may alternatively be a wearable device. The wearable device may also be referred to as a wearable intelligent device, and is a general term of wearable devices, such as glasses, gloves, watches, clothing, and shoes, that are intelligently designed and developed for daily wear by using a wearable technology. The wearable device is a portable device that can be directly worn on a body or integrated into clothes or an accessory of a user. The wearable device is not only a hardware device, but also implements a powerful function through software support, data exchange, and cloud interaction. In a broad sense, wearable intelligent devices include devices with full-featured and large-size that can implement complete or partial functions without depending on smartphones, such as smart watches or smart glasses, and devices that focus only on one type of disclosure function and need to work with other devices such as smartphones, for example, various smart bands or smart jewelry for monitoring physical signs.

In addition, the terminal device in this embodiment of this disclosure may alternatively be a terminal device in an IoT system. The IoT is an important part in future information technology development. A main technical feature of the IoT is connecting a thing to a network based on a communication technology, to implement an intelligent network of human-machine interconnection and thing-thing interconnection.

It should be noted that the terminal device and the access network device may communicate with each other based on an air interface technology (for example, a new radio (NR) technology or an LTE technology). Terminal devices may also communicate with each other based on an air interface technology (for example, an NR technology or an LTE technology).

In this embodiment of this disclosure, an apparatus configured to implement a function of the terminal device may be a terminal device, or may be an apparatus, for example, a chip system or a chip, that can support the terminal device in implementing the function. The apparatus may be installed in the terminal device. In this embodiment of this disclosure, the chip system may include a chip, or may include a chip and another discrete component.

2. A (radio) access network ((R)AN) device may provide an authorized user in an area with a function of accessing a communication network, and may include a wireless network device in a 3rd generation partnership project (3GPP) network, or may include an access point in a non-3GPP network. For ease of description, the RAN device is used in the following descriptions.

The RAN device may use different radio access technologies. Currently, there are two types of radio access technologies: a 3GPP access technology (for example, a wireless access technology used in a 3rd generation (3G) system, a 4th generation (4G) system, or a 5G system) and a non-3GPP access technology. The 3GPP access technology is an access technology that complies with a 3GPP standard specification. For example, an access network device in the 5G system is referred to as a next generation node base station (gNB) or a RAN device. The non-3GPP access technology may include an air interface technology represented by an access point (AP) in wireless fidelity (Wi-Fi), worldwide interoperability for microwave access (WiMAX), code division multiple access (CDMA), and the like. The AN device may allow interconnection and interworking between a terminal device and a 3GPP core network based on the non-3GPP technology.

The RAN device can be responsible for functions such as radio resource management, quality of service (QoS) management, data compression, and encryption on an air interface side. The AN device provides the terminal device with an access service, to complete forwarding of a control signal and user data between the terminal device and the core network.

For example, the RAN device may include but is not limited to a macro base station, a micro base station (also referred to as a small cell), a radio network controller (RNC), a NodeB (NB), a base station controller (BSC), a base transceiver station (BTS), a home base station (for example, a home evolved NodeB, or a home NodeB, HNB), a baseband unit (BBU), an AP in a Wi-Fi system, a wireless relay node, a wireless backhaul node, a transmission point (TP), a transmission and reception point (TRP), or the like; or may be a gNB or a transmission point (TP) in a 5G (for example, NR) system, or one antenna panel or a group of antenna panels (including a plurality of antenna panels) of a base station in a 5G system; or may be a network node forming a gNB or a transmission point, for example, a distributed unit (DU), a base station in a next-generation 6G communication system, or the like. A technology and a device form used by the AN device are not limited in embodiments of this disclosure.

3. A user plane function network element (UPF) may be configured to perform packet routing and forwarding, quality of service (QoS) processing on user plane data, or the like. User data may be accessed to a data network (DN) through the network element. In this embodiment of this disclosure, the user plane function network element may be configured to implement a function of the user plane network element.

4. An access and mobility management function (AMF) network element is mainly configured to perform mobility management, access management, and the like, and may be configured to implement a function other than session management in mobility management entity (MME) functions, for example, a function such as lawful interception or access authorization (or authentication). In this embodiment of this disclosure, the access and mobility management function network element may be configured to implement a function of the access and mobility management network element.

5. A session management function network element (SMF) is mainly configured to perform session management, allocate and manage an IP address of a terminal device, select and manage a termination point of a user plane function, policy control, or a charging function interface, perform downlink data notification, and the like. In this embodiment of this disclosure, the session management function network element may be configured to implement a function of the session management network element.

6. A policy control function (PCF) network element is configured to provide a unified policy framework for guiding network behavior, provide a control plane function network element (for example, an AMF or SMF network element) with policy rule information, and the like.

7. A network exposure function (NEF) network element is configured to securely expose, to the outside, service information and capability information (such as a terminal location and a network congestion state) provided by a 3GPP network function network element.

8. A network repository function (NRF) network element is configured to store description information of a network functional entity and description information of a service provided by the network functional entity, and support functions such as service discovery and network element entity discovery, and the like.

9. An authentication server function (AUSF) network element is mainly configured to perform user authentication and the like.

10. A unified data management (UDM) network element is configured to perform unified data management, 5G user data management, user identity processing, access authentication, registration, mobility management, or the like.

11. A data network (DN) is a network used to provide data transmission, for example, an operator service network, the Internet, or a third-party service network. For example, the DN may include an application (App) and a mobile edge computing platform (MEP).

12. An application function (AF) network element is configured to perform data routing affected by an application, access a network exposure function network element, interact with a policy framework to perform policy control, or the like. In this disclosure, the AF may also be understood as an application server.

13. A mobile edge computing (MEC) node (where the MEC may also be referred to as multi-access edge computing) may be considered as a cloud server running at an edge of a mobile network and running tasks. The European Telecommunications Standards Institute (ETSI) defines the MEC as a platform that provides a user with an IT architecture and a cloud computing capability on a RAN network close to a mobile user. The MEC is deployed on a radio network. Generally, the MEC is actually deployed on an edge UPF network element of a 5G core network. The edge UPF implements local offloading and traffic sheering of a service through an N6 interface between the edge UPF and a local data network (DN), to implement localized processing of the service and achieve an acceleration effect.

In the network architecture shown in FIG. 1, the network elements may communicate with each other through interfaces shown in the figure. As shown in the figure, an N1 interface is a reference point between the terminal device and the AMF. An N2 interface is a reference point between the RAN and the AMF, and is used to send a non-access stratum (NAS) message and the like. An N3 interface is a reference point between the RAN and the UPF, and is used to transmit user plane data and the like. An N4 interface is a reference point between the SMF and the UPF, and is used to transmit information such as identification information of a tunnel connected to N3, data buffering indication information, and a downlink data notification message. An N5 interface is a reference point between the PCF and the AF. An N6 interface is a reference point between the UPF and the DN, and is used to transmit the user plane data and the like. An N7 interface is a reference point between the SMF and the PCF. An N9 interface is an interface between UPFs, for example, an interface between a visited-policy control function (V-PCF) and a home-policy control function (H-PCF), or an interface between a UPF connected to the DN and a UPF connected to the RAN, and is used to transmit the user plane data between the UPFs. An N33 interface is a reference point between the NEF and the AF. For brevity, relationships between other interfaces and the network elements are not described in detail herein.

It should be understood that the network architecture shown in FIG. 1 is merely an example for description, and a network architecture applicable to embodiments of this disclosure is not limited thereto. Any network architecture that can implement functions of the foregoing network elements is applicable to embodiments of this disclosure.

It should be further understood that the functions or the network elements such as the AMF, the SMF, the UPF, the PCF, and the UDM shown in FIG. 1 may be understood as network elements configured to implement different functions, for example, may be combined into a network slice as required. These network elements may be independent devices, or may be integrated into a same device to implement different functions, or may be network components in a hardware device, or may be software functions running on dedicated hardware, or may be instantiated virtualization functions on a platform (for example, a cloud platform). Specific forms of the network elements are not limited in this disclosure.

It should be further understood that the foregoing names are defined merely for distinguishing between different functions, and should not be construed as any limitation on this disclosure. This disclosure does not exclude a possibility of using other names in a 6G network and another future network. For example, in the 6G network, some or all of the foregoing network elements may still use terms in 5G, or may use other names.

FIG. 2 is a schematic of a communication architecture to which this disclosure is applicable. As shown in FIG. 2, a computing management control function (CMF) network element is introduced in this embodiment of this disclosure. Refer to FIG. 2. The CMF collaborates with an access network device (for example, a base station) to support convergence scheduling of computing power and communication. The CMF may be located in a core network, and is connected to the access network device through an NG_AP interface. Alternatively, the CMF may be co-located with the access network device. When functioning as a network element in the core network, the CMF may be relayed by an AMF or directly connected to a RAN.

In this disclosure, the CMF may implement computing power management and computing bearer management, and may further collaborate with an SMF, to implement joint adjustment of connections and computing resources. In addition, a terminal uses computing services of a base station and the core network through an air interface. The CMF may include a non-access stratum (NAS). The NAS implements registration management, authentication access control, and session management of a UE.

In this disclosure, a radio access network device has a convergence scheduling (CS) function, and the CS function includes one or more of the following: computing power state sensing and sensing result reporting, establishment, modification, suspension, restoration, and release of a heterogeneous computing power resource of a terminal, computing power control, and computing bearer management.

A management/control granularity of the CMF may be different from that of the access network device. Optionally, a time granularity is different. For example, a time granularity corresponding to the CMF may be at a 10 ms level, a 100 ms level, or the like, while a time granularity corresponding to the access network device may be at a millisecond level. Optionally, a range granularity is different. The CMF may manage computing power of a plurality of cells within a city range, and the access network device may control computing power of one or more cells within a coverage area of the access network device.

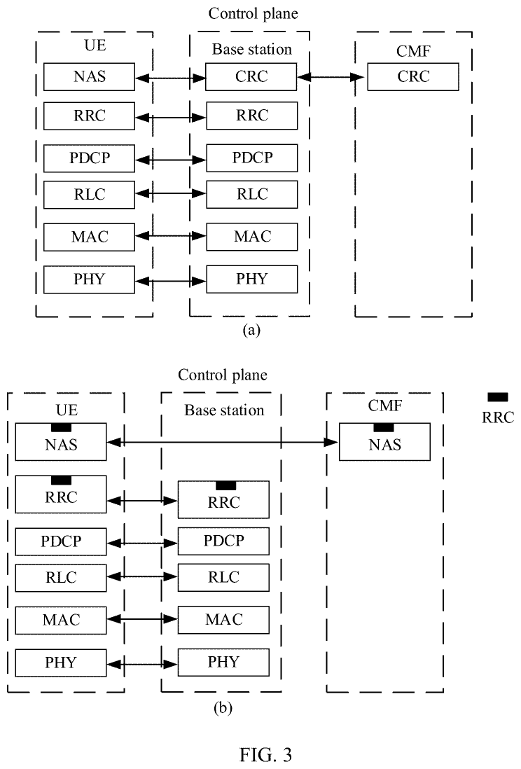

FIG. 3 is a schematic of a protocol stack architecture to which this disclosure is applicable. As shown in FIG. 3, a control plane of the protocol stack architecture includes a plurality of layers, for example, a computing resource control (CRC) layer, a radio resource control (RRC) layer, a packet data convergence protocol (PDCP) layer, a radio link control (RLC) layer, a media access control (MAC) layer, and a physical layer (PHY). As shown in (a) in FIG. 3, the CRC layer may be above the RRC layer, and a UE, a base station, and a core network computing management control function all have a computing resource control layer. As shown in (b) in FIG. 3, the CRC layer may alternatively be an information element or an RRC container in the RRC layer, or an information element or a NAS container in the NAS. The protocol stack architecture further includes a CMF network element.

The UE may perform signaling exchange with a core network via the base station. An RRC signaling exchange module may be a module used by the base station and the UE to send and receive RRC signaling. AMAC signaling exchange module may be a module used by the base station and the UE to send and receive MAC control element (CE) signaling. A PHY signaling and data exchange module may be a module used by the base station and the UE to send and receive uplink or downlink control signaling through, for example, a physical uplink control channel (PUCCH) and a physical downlink control channel (PDCCH), and send and receive uplink or downlink data through, for example, a physical uplink shared channel (PUSCH) and a physical downlink shared channel (PDSCH).

In one embodiment, to implement convergence of computing power and communication, in this embodiment of this disclosure, the CRC layer is defined in a control plane protocol stack to control a computing resource. In one embodiment, the CRC is used for computing resource control, and is used to implement a computing control part in a CS function at a protocol layer, for example, computing power state sensing and sensing result reporting, establishment, modification, suspension, restoration, and release of a heterogeneous computing power resource of a terminal, and computing power control.

When a transmitting end and a receiving end are a terminal or an access network device, a CRC message is sequentially processed at the transmitting end by using an RRC layer, a PDCP layer, an RLC layer, a MAC layer, and a PHY layer, and is sent by the transmitting end to the receiving end at the physical layer. After the CRC message is received at a PHY layer of the receiving end, the CRC message is sequentially processed at a MAC layer, an RLC layer, a PDCP layer, and an RRC layer, so that the receiving end may parse the CRC message at a CRC layer. The CRC message may include computing-related data and/or control signaling. The terminal and the access network device may alternatively exchange the CRC message with the CMF.

Without limitation, there may be no other protocol layers between the CRC layer and the RRC layer, or there may be another protocol layer, for example, a protocol layer introduced in the future. Optionally, the CRC layer may be parallel to a non-access stratum (NAS).

In one embodiment, in this embodiment of this disclosure, a CRC function is implemented by using the RRC layer and/or the NAS. The CRC function may include: computing power state sensing and sensing result reporting, establishment, modification, suspension, restoration, and release of a heterogeneous computing power resource of a terminal, computing power control, and the like.

When the CRC function is implemented by using the RRC layer, the CRC function may be implemented by defining a new RRC message, and adding a new information element (IE) to the RRC message, or adding a new RRC container. A terminal and an access network device may exchange CRC-related information by using an RRC message. For example, an RRC message for implementing the CRC function is sequentially processed at the transmitting end by using a PDCP layer, an RLC layer, a MAC layer, and a physical layer, and is sent by the transmitting end to the receiving end at the physical layer. After corresponding data/signaling is received at a physical layer of the receiving end, the data/signaling is sequentially processed at the MAC layer, the RLC layer, and the PDCP layer, so that the receiving end may parse, at the RRC layer, the RRC message for implementing the CRC function.

When the CRC function is implemented by using the NAS, the CRC function may be implemented by using a newly added NAS IE or NAS container. The terminal and the CMF may exchange a NAS message to implement the CRC function.

It can be learned from the system architecture in FIG. 1 that the MEC is an invisible network element in the 5G system architecture, and does not belong to a network architecture scope defined in the 5G. Therefore, the MEC does not directly affect the 5G system architecture. In an MEC application, a service data processing location is moved from a remote data network (usually a public cloud) to a local MEC based on an existing local traffic steering mechanism of a 5G core network. This is the essence of the MEC to implement service acceleration. In other words, an application for processing service data may be downward deployed from a physical deployment location to a location near a core network of the radio network as much as possible, that is, the application is co-located with a network element UPF in the core network, or downward deployed to a location near the base station, that is, the application is co-deployed with the base station on a physical node. MEC deployment satisfies requirements of the industry for real-time performance and data security to some extent.

However, in the 5G architecture, the network and a computing part are still relatively loosely coupled. In other words, the 5G architecture does not truly implement a capability of native computing power of the network. This is because in the 5G architecture, service deployment on the computing power is implemented through a management plane, is not dynamic, and cannot unify the network and the computing power on the control plane. In other words, user movement and a network change cannot be responded in time. Therefore, when a computing power capability of the terminal device or the network device changes and a connection policy needs to be adjusted, or when the connection policy changes and computing power needs to be adjusted, the control plane usually cannot respond in time, resulting in a long adjustment delay (for example, generating a minute-level adjustment delay). Therefore, in the current 5G architecture, how to improve efficiency of sensing the computing power capability of the terminal device or the network device by the control plane becomes a technical problem that needs to be resolved.

This disclosure provides a computing power capability sensing method. A first device obtains, by receiving first signaling, a type and/or a granularity of a computing power capability that needs to be reported, so that efficiency of sensing the computing power capability of the first device by a network device (for example, a RAN, a CMF, or understood as a “control plane network element”) may be improved. In other words, a second device may indicate the type and/or the granularity of the computing power capability reported by the first device, so that the network device may subsequently perform dynamic computing power scheduling, adjust a computing power scheduling policy, and so on, based on the computing power capability reported by the first device, to improve efficiency of configuring network computing power.

It should be understood that the “signaling” in this disclosure may be control information or higher layer signaling. For example, the control information may be downlink control information (DCI) or uplink control information (UCI). For example, the higher layer signaling may be radio resource control (RRC) signaling or media access control-control element (MAC CE) signaling. Types of different signaling may be the same or may be different. For example, the signaling may be the DCI or the UCI, or may be the RRC signaling, a system information block (SIB), or the MAC CE signaling. This is not limited in this disclosure.

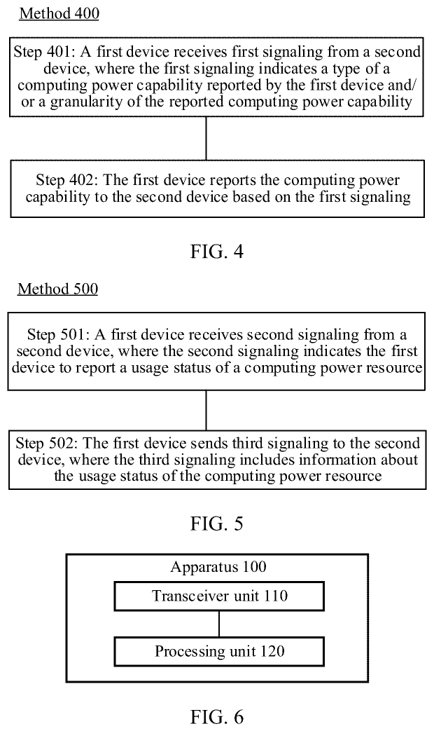

FIG. 4 is a schematic flowchart of a computing power capability sensing method 400 according to this disclosure. As shown in FIG. 4, the method includes the following operations.

Operation 401: A first device receives first signaling from a second device, where the first signaling indicates a type of a computing power capability reported by the first device and/or a granularity of the reported computing power capability. Correspondingly, the second device sends the first signaling to the first device.

In this disclosure, the first device may be, for example, a terminal device (the following uses a “UE” as an example for description). For another example, the first device may be a radio access network device (the following uses a “base station” as an example for description). The second device may be, for example, a radio access network device. For another example, the second device may be a CMF. For example, when the first device is the UE, the second device may be, for example, the base station. When the first device is the base station, the second device may be, for example, the CMF. It should be noted that, in the following embodiments, an example in which the first device is the UE and the second device is the base station is mainly used for description. A case in which the first device is the base station and the second device is the CMF is similar. For example, the CMF indicates the type and/or the granularity of the reported computing power capability to the base station. Correspondingly, the base station may report a sum of this type of computing power capabilities of one or more UEs served by the base station to the CMF. For another example, the base station may report this type of a computing power capability of the base station to the CMF. For still another example, the base station may report an average value of this type of computing power capabilities of one or more UEs served by the base station to the CMF. For yet another example, the base station may report this type of a computing power capability of the base station and a sum of this type of computing power capabilities of one or more UEs served by the base station to the CMF. Details are not described in the following.

In this disclosure, the type of the computing power capability reported by the UE may include, for example, one or more of the following: a processor of the UE (for example, a center processing unit (CPU), a graphic processing unit (GPU), a tensor processing unit (TPU), a neural network processing unit (NPU), and a field-programmable gate array (FPGA)), storage space of the UE, a memory of the UE, and a state of charge of the UE. This is not limited.

In an example, the first signaling may indicate a computing power capability of the NPU and a computing power capability of the storage space that are reported by the UE. For another example, the first signaling may indicate a computing power capability of the state of charge, a computing power capability of the memory, a computing power capability of the NPU, a computing power capability of the CPU, and the like that are reported by the UE. In one embodiment, the first signaling includes an indication field #1, and the indication field #1 may indicate the computing power capability of the NPU and the computing power capability of the storage space that are reported by the UE. In this disclosure, the first signaling may be sent to prevent the UE whose type of the computing power capability does not satisfy a requirement of the base station from reporting terminal computing power, thereby reducing invalid reporting and a waste of bandwidth resources.

In this disclosure, the first signaling indicates the granularity of the computing power capability reported by the UE. For example, the first signaling may indicate that the UE reports the computing power capability of the CPU based on a granularity of X (where X is an integer greater than 0, for example, X is 1/10/100). For another example, the first signaling may indicate that the UE reports the computing power capability of the storage space based on a granularity of Y MB (where Y is an integer greater than 0, for example, Y is 1/10/100). For example, the first signaling may indicate that the UE reports the computing power capability of the storage space based on a granularity of W MB (where W is an integer greater than 0, for example, W is 1/10/100, and W and Y may be the same or different). For another example, the first signaling may indicate that the UE reports the computing power capability of the state of charge based on a granularity of Z % (where Z is an integer greater than 0, for example, Z is 1/5/10). It may also be understood that, when scheduling the CPU, the base station may perform scheduling based on a granularity of 1/10/100, or when scheduling the storage space, the base station may perform scheduling based on a granularity of 1 MB/10 MB/100 MB, or when scheduling the state of charge, the base station may perform scheduling based on a granularity of 1%/5%/10%. In one embodiment, the first signaling includes an indication field #2, and the indication field #2 may indicate the granularity of the computing power capability reported by the first device.

In an example, the first signaling may indicate that a reporting granularity of the NPU of the UE is 100. For another example, the first signaling may indicate that a reporting granularity of the storage space of the UE is 10 MB. For another example, the first signaling may indicate that a reporting granularity of the GPU of the UE is 10, a reporting granularity of the state of charge is 10%, a reporting granularity of the memory is 1 MB, and the like. In this disclosure, a UE whose computing power capability is less than a scheduling granularity of the base station may be prevented from reporting the computing power capability, thereby reducing computing power reporting overheads.

In another example, the first signaling may indicate the computing power capability of the NPU and the computing power capability of the storage space that are reported by the UE, and the first signaling may indicate that a reporting granularity of the NPU is 10, and a reporting granularity of the storage space is 100 MB. For another example, the first signaling may indicate the computing power capability of the state of charge, the computing power capability of the memory, the computing power capability of the NPU, and the computing power capability of the CPU that are reported by the UE, and the first signaling may indicate that a reporting granularity of the state of charge is 5%, a reporting granularity of the memory is 10 MB, a reporting granularity of the NPU is 100, a reporting granularity of the CPU is 10, and the like.

In one embodiment, the first signaling includes an indication field #1, and the indication field #1 may indicate both the type of a computing power capability reported by the UE and/or the granularity of the reported computing power capability. In one embodiment, the first signaling may include an indication field #1 and an indication field #2. The indication field #1 indicates the type of the computing power capability reported by the first device, the indication field #2 indicates the granularity of the computing power capability reported by the first device, and the like.

In this disclosure, the first signaling may further indicate a computing power capability type combination (where the “combination” may also be understood as a “NAS container”) reported by the UE. For example, the first signaling may indicate a computing power capability type combination #0, and the computing power capability type combination #0 may be, for example, one or more of types such as the CPU, the GPU, the NPU, the FPGA, storage space, the memory, and the state of charge.

In this disclosure, the first signaling may further indicate a quantity of granularity combinations (where the “combination” may also be understood as “NAS containers”) reported by the UE. For example, the first signaling indicates a granularity combination #1, where the granularity combination #1 includes a reporting granularity of the CPU being 10, and a reporting granularity of the storage space being 100 MB. Subsequently, the UE may report a quantity of granularity combinations #1 (that is, NAS containers). Assuming that the UE has 100 CPUs and 1000 MB storage space, the UE may directly report 10 granularity combinations #1 (that is, NAS containers).

Operation 402: The first device reports the computing power capability to the second device based on the first signaling.

In this disclosure, the UE may report the computing power capability by using one of layer 1 (L1) signaling, layer 2 (L2) signaling, or layer 3 (L3) signaling or signaling. In this disclosure, a manner of reporting the computing power capability may alternatively be predefined. For example, it may be pre-stipulated that the L1 signaling, the L2 signaling, or the L3 signaling is used to report the computing power capability.

In an example, the first signaling indicates that types of computing power capabilities reported by the UE are the CPU and the state of charge, and the first signaling indicates that a reporting granularity of the CPU of the UE is 10 and a reporting granularity of the state of charge is 10%. It is assumed that the computing power capability of the CPU of the UE is 100, and the computing power capability of the state of charge is 90%. In this case, the UE may report the computing power capability of the CPU and the computing power capability of the state of charge based on an indication of the first signaling. For example, the UE may send the L1 signaling to the terminal device. The signaling may include indication information of four bits (0000 to 1111). For example, a bit value “0001” indicates that the computing power capability of the CPU of the UE is 10, and a bit value “0010” indicates that the computing power capability of the CPU of the UE is 20. If the computing power capability of the CPU of the UE is 100, a bit value of the indication information may be, for example, “1010”. For another example, if the first signaling indicates that the reporting granularity of the state of charge of the UE is 10%, and the computing power capability of the state of charge is 90%, a bit value of the indication information included in the first signaling may be “1001”.

In one embodiment, the UE may indicate, to the base station by using a random access preamble (an example of the L1 signaling), whether the reporting granularity that is greater than the computing power capability and the reporting type that are indicated in the first signaling sent by the base station are included. For example, the base station may broadcast a group of random access preambles. If the UE uses a preamble of a group #0, it indicates that the type of the computing power capability of the UE is less than the reporting granularity indicated by the base station. If the UE uses a preamble of a group #1, it indicates that the type of the computing power capability of the UE is greater than or equal to the reporting granularity indicated by the base station.

In one embodiment, the UE may report, by using an MAC CE signaling (an example of the L2 signaling), a quantity of computing power capability granularity combinations supported by the first device.

In one embodiment, the UE may report, by using UE capability information (an example of the L3 signaling), the type of the computing power capability or the quantity of computing power capability granularity combinations of the UE. For example, a logical computing capability and a parallel computing capability of the UE may be reported by using the UE capability information. Alternatively, a UE neural network computing capability, a dedicated computing capability, and other types of computing power capabilities may be reported. Alternatively, a storage space capability and a state of charge capability of the UE may be reported. For example, the parallel computing capability of the UE may include a frequency of the CPU, a quantity of CPU cores, a quantity of times of multiplication and addition calculation supported by the CPU per second, a quantity of times of dot multiplication of the CPU, a quantity of times of convolution of the CPU, a quantity of times of floating-point calculation of the CPU, a quantity of operations, and the like.

Based on the foregoing technical solution, in this disclosure, the first device obtains, by receiving the first signaling, the type and/or the granularity of the computing power capability that needs to be reported. In other words, the type and/or the granularity of the computing power capability reported by the first device may be indicated, so that a control plane (for example, the base station or the CMF) in a network may subsequently perform dynamic computing power scheduling, adjust a computing power scheduling policy, and so on based on information about the computing power capability reported by the first device, to improve efficiency of configuring network computing power.

FIG. 5 is a schematic flowchart of a computing power capability sensing method 500 according to this disclosure. As shown in FIG. 5, the method includes the following operations.

Operation 501: A first device receives second signaling from a second device, where the second signaling includes identification information, the identification information identifies a computing power resource, and the second signaling indicates the first device to report a usage status of the computing power resource. Correspondingly, the second device sends the second signaling to the first device.

The “computing power resource” in this disclosure may be understood as a resource corresponding to a computing power capability of the first device. For example, the computing power resource may be one or more resources in a computing resource container, a processor, a storage space, a memory, or a state of charge.

The “identification information” in this disclosure may include, for example, a computing power configuration identifier and a computing power configuration index.

In one embodiment, a computing power configuration identifier #1 may identify a computing power resource #1, and the computing power resource #1 may be understood as a resource corresponding to a computing power capability #1 of the UE. In an example, the computing power capability #1 of the UE may be a computing power capability of a processor of the UE. In this case, the computing power resource #1 may be understood as a resource corresponding to the computing power capability of the processor of the UE. For another example, the computing power capability #1 of the UE may be a computing power capability of the storage space and a computing power capability of the memory of the UE. In this case, the computing power resource #1 may be understood as resources corresponding to the computing power capability of the storage space and the computing power capability of the memory of the UE. For another example, the computing power resource #1 may be a resource corresponding to a computing power capability of the state of charge of the UE. Certainly, the computing power resource #1 may also be understood as resources corresponding to various computing power capability type combinations of the UE. For example, the computing power resource #1 may be understood as resources corresponding to the computing power capability of the processor, the computing power capability of the storage space, and the computing power capability of the memory of the UE. For another example, the computing power resource #1 may be understood as resources corresponding to the computing power capability of the storage space and the computing power capability of the state of charge of the UE.

In this disclosure, the computing power resource #1 may include a granularity of the computing power capability of the UE. In an example, a scheduling granularity of the CPU included in the computing power resource #1 is 1/10/100. For another example, a scheduling granularity of the storage space and the memory of the UE included in the computing power resource #1 is 1 MB/10 MB/100 MB. For another example, a scheduling granularity of the state of charge of the UE included in the computing power resource #1 is 1%/5%/10%.

In one embodiment, a computing power configuration index #2 may identify a computing power resource #2, and the computing power resource #2 may be understood as a resource corresponding to a computing power capability #2 of the UE. For example, the computing power resource #2 may be a resource corresponding to the computing power capability of the storage space of the UE. For another example, the computing power resource #2 may be resources corresponding to computing power capabilities of the CPU, the NPU, or the state of charge of the UE. As described above, the computing power resource #2 may also include a granularity of the computing power capability of the UE. For example, a scheduling granularity of the CPU included in the computing power resource #2 is 100. For another example, a scheduling granularity of the storage space and the memory of the UE included in the computing power resource #2 is 1 MB. For another example, the scheduling granularity of the state of charge of the UE included in the computing power resource #2 is 10%.

Operation 502: The first device sends third signaling to the second device, where the third signaling includes information about the usage status of the computing power resource. Correspondingly, the second device receives the third signaling.

In one embodiment, for example, the third signaling includes an indication field #A, the indication field #A has one bit, and a bit value “0” indicates that a usage status of a computing power resource corresponding to the identification information is “idle”; and a bit value “1” of the indication field #A indicates that a usage status of a computing power resource corresponding to the identification information is “occupied”.

In an example, for example, the UE may send the information about the usage status of the computing power resource by using short media access control-control element (short MAC CE) signaling or long MAC CE signaling. For example, the short MAC CE signaling may include indication information of types of computing power capabilities (for example, computing power of a logic type, computing power of a parallel computing type, computing power of a neural network type, a storage capability, and a state of charge). For example, in the indication information, “type0” indicates the computing power of the logical type, “type1” indicates computing power of a graphic processing unit type, “type2” indicates the computing power of the neural network computing type, “type3” indicates the storage capability, and “type4” indicates the state of charge. For example, the indication information further includes an indication field #A0, an indication field #A1, an indication field #A2, an indication field #A3, and an indication field #A4. The indication field #A0 indicates a usage status of a computing power resource corresponding to “type0”. For example, the indication field #A0 is “0”. The indication field #A1 indicates a usage status of a computing power resource corresponding to “type1”. For example, the indication field #A1 is “1”.

In another example, a short MAC CE signaling (an example of L2 signaling) may include identification information corresponding to a computing power capability type combination. For example, “type0” may represent a resource corresponding to a computing power capability type combination #0, and the computing power capability type combination #0 may be, for example, one or more of types such as a CPU, a GPU, an NPU, an FPGA, a storage space, a memory, and a state of charge. “type #1” may represent a resource corresponding to a computing power capability type combination #1, and the computing power capability type combination #1 may be another computing power capability type combination. Similarly, the indication information further includes an indication field #A0 and an indication field #A1. The indication field #A0 indicates a usage status of a computing power resource corresponding to “type0”. For example, the indication field #A0 is “1”. For example, the indication field #A1 indicates a usage status of a computing power resource corresponding to “type1”. For example, the indication field #A1 is “1”.

In one embodiment, for example, the third signaling includes an indication field #B, and the indication field #B may have N bits (where N is an integer greater than 1). For example, the indication field #B is two bits, and bit states “00”, “01”, “10”, and “11” may respectively indicate that utilization ratios of a computing power resource corresponding to the identification information are “1% to 25%”, “26% to 50%”, “51% to 75%”, and “76% to 100%”. For example, the computing power capability of the CPU of the UE is 100, and a utilization state of a computing power resource corresponding to the computing power capability of the CPU is 60%. In this case, a bit value of the indication field #B is “10”.

For example, the UE may periodically send the third signaling to a base station. For example, duration of a timer may be predefined, and the UE may periodically send the third signaling to the base station. For another example, the base station may preconfigure a periodicity for sending the third signaling by the UE.

For example, a threshold of the utilization ratio of the computing power resource may be preconfigured. For example, the threshold is 70%. When the utilization ratio of the computing power resource exceeds the configured threshold, for example, a current utilization ratio of the computing power resource of the UE is 80%, the UE may send the third signaling to the base station.

For example, the duration of the timer may be preconfigured. If the timer expires, the UE may report the utilization ratio of the computing power resource of the UE by using the long MAC CE signaling. For another example, the threshold of the utilization ratio of the computing power resource may be preconfigured. If the UE determines that the current utilization ratio of the computing power resource exceeds the configured threshold, the UE may report the utilization ratio of the computing power resource of the UE by using the short MAC CE signaling. For still another example, when the utilization ratio of the computing power resource of the UE exceeds the threshold, the UE may start the timer. If the utilization ratio of the computing power resource is less than or equal to the threshold before the timer expires, the UE may not send the utilization ratio of the computing power resource to the base station. If the utilization ratio of the computing power resource is still greater than the threshold after the timer expires, the UE may report the utilization ratio of the computing power resource by using the short MAC CE signaling.

As shown in FIG. 6, the short MAC CE signaling may include two indication fields. An indication field #1 is type identification information (type ID), and an indication field #2 is a resource utilization ratio. For example, the indication field #1 may have three bits, and the indication field #2 may have five bits. For example, when a bit value of the indication field #1 is “000”, the bit value indicates a resource corresponding to a computing power capability type “type #0” of the UE. For example, “type0” may represent a resource corresponding to a computing power capability type combination #0. The computing power capability type combination #0 may be, for example, one or more of types such as a CPU, a GPU, an NPU, an FPGA, a storage space, a memory, and a state of charge. For example, a bit value of the indication field #2 may be “0001”, that is, a utilization ratio of a computing power resource of “type #0” of the UE is 1% to 10%. For another example, a bit value of the indication field #2 may be “0011”, that is, a utilization ratio of a computing power resource of “type #0” of the UE is 20% to 30%.

As shown in FIG. 6, the long MAC CE signaling may include type identification information and indication information of a utilization ratio of the computing power resource. The type identification information may have eight bits, respectively corresponding to eight types of resources, for example, “type0” to “type8”. The indication information of the utilization ratio of the computing power resource indicates the eight types of resources. For example, indication information of a resource utilization ratio #0 indicates a resource utilization ratio of “type0”; indication information of a resource utilization #1 indicates a resource utilization ratio of “type1”, indication information of a resource utilization ratio #3 indicates a resource utilization ratio of “type3”; and indication information of a resource utilization ratio #7 indicates a resource utilization ratio of “type7”. Details are not described again.

Based on the foregoing technical solution, in this disclosure, the UE or a RAN reports the usage status of the computing power resource by receiving the second signaling, so that a control plane in a network may subsequently perform dynamic computing power scheduling, adjust a computing power scheduling policy, and so on based on the usage status of the computing power resource reported by the UE or the RAN, to improve efficiency of configuring network computing power.

It should be noted that, in this disclosure, the method 400 and the method 500 may also be combined. For example, the method 400 may be performed first, in other words, the UE may report the computing power capability to the base station, and then the UE reports the usage status of the resource corresponding to the computing power capability to the base station.

It may be understood that the examples in the method 400 and the method 500 in embodiments of this disclosure are merely intended to help a person skilled in the art understand embodiments of this disclosure, and are not intended to limit embodiments of this disclosure to scenarios shown in the examples. Evidently, a person skilled in the art may make various equivalent modifications or changes based on the examples of the method 400 and the method 500, and such modifications or changes also fall within the scope of embodiments of this disclosure.

It should be understood that “predefined” in this disclosure may be understood as “defined”, “predefined”, “pre-stipulated”, “stored”, “pre-stored”, “pre-negotiated”, “pre-configured”, “solidified”, or “pre-burned”. These definitions may also be replaced with each other.

It may be understood that the term “and/or” in this specification describes merely an association relationship between associated objects and represents that three relationships may exist. For example, A and/or B may represent the following three cases: Only A exists, both A and B exist, and only B exists. In addition, the character “/” in this specification generally represents an “or” relationship between the associated objects.

It should be further understood that numbers “first” and “second” introduced in embodiments of this disclosure are merely intended to distinguish between different objects, for example, distinguish between different “signaling”, and should not be construed as any limitation on embodiments of this disclosure.

It should be further understood that, in the foregoing embodiments, the terminal device and/or the network device may perform some or all of the operations in embodiments. These operations are merely examples. Other operations or variations of various operations may be further performed in embodiments of this disclosure. In addition, the operations may be performed in different sequences presented in embodiments, and not all operations in embodiments of this disclosure may need to be performed. In addition, sequence numbers of the operations do not mean execution sequences. The execution sequences of processes should be determined based on functions and internal logic of the processes, and should not be construed as any limitation on implementation processes of embodiments of this disclosure. For example, when the method 400 is implemented in combination with the method 500, the method 400 may be performed first, or the method 500 may be performed first. This is not limited.

It may be further understood that some optional features in embodiments of this disclosure may be independent of other features in some scenarios, or may be combined with other features in some scenarios. This is not limited.

It should be understood that embodiments described in this disclosure may be independent solutions, or may be combined based on internal logic. These solutions all fall within the protection scope of this disclosure. In addition, explanations or descriptions of terms in embodiments may be mutually referenced or explained in embodiments, which is not limited.

In the foregoing embodiments provided in this disclosure, the methods provided in embodiments of this disclosure are separately described from perspectives of the network device, the terminal device, and interaction between the network device and the terminal device. To implement functions in the methods provided in embodiments of this disclosure, the network device and the terminal device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular disclosures and design constraint conditions of the technical solutions.

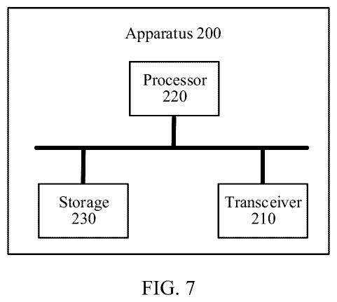

FIG. 6 and FIG. 7 each are a diagram of a structure of a possible computing power capability sensing apparatus according to an embodiment of this disclosure. These communication apparatuses may implement functions of the terminal device or the network device in the foregoing method embodiments. Therefore, beneficial effects of the foregoing method embodiments can also be implemented. In embodiments of this disclosure, the communication apparatus may be the terminal device or the radio access network device in FIG. 1, or may be a module (for example, a chip) used in the terminal device or the access network device.

As shown in FIG. 6, the computing power capability sensing apparatus 100 includes a transceiver unit 110 and a processing unit 120. The computing power capability sensing apparatus 100 may be configured to implement functions of the terminal device or the radio access network device in the method embodiments shown in the method 400 and the method 500.

When the computing power capability sensing apparatus 100 is configured to implement the functions of the terminal device in the method embodiments of the method 400 and the method 500, the transceiver unit 110 is configured to receive first signaling, where the first signaling indicates a type of a computing power capability reported by the apparatus and/or a granularity of the reported computing power capability; and the processing unit 120 is configured to indicate, based on the first signaling, the transceiver unit to further report the computing power capability.

In one embodiment, the transceiver unit 110 is further configured to receive second signaling, where the second signaling includes identification information, the identification information identifies a computing power resource, the second signaling indicates the apparatus to report a usage status of the computing power resource, and the computing power resource is a resource corresponding to the computing power capability of the apparatus. The transceiver unit 110 is further configured to send third signaling, where the third signaling includes information about the usage status of the computing power resource.

In one embodiment, the transceiver unit periodically sends the third signaling, or when the processing unit 120 determines that a utilization ratio of the computing power resource exceeds a configured threshold, the processing unit 120 is configured to indicate the transceiver unit 110 to send the third signaling.

When the computing power capability sensing apparatus 100 is configured to implement the functions of the network device (for example, a base station or a CMF network element) in the method embodiments of the method 400 and the method 500, the transceiver unit 110 is configured to send first signaling, where the first signaling indicates a type of a reported computing power capability and/or a granularity of the reported computing power capability; and the transceiver unit 110 is further configured to receive the reported computing power capability.

In one embodiment, the transceiver unit 110 is further configured to send second signaling, where the second signaling includes identification information, the identification information identifies a computing power resource, the second signaling indicates a usage status of the reported computing power resource, and the computing power resource is a resource corresponding to the computing power capability of the apparatus. The transceiver unit 110 is further configured to receive third signaling, where the third signaling includes information about the usage status of the computing power resource.

In one embodiment, the transceiver unit 110 is further configured to periodically receive the third signaling, or when a utilization ratio of the computing power resource exceeds a configured threshold, the transceiver unit 110 is configured to receive the third signaling.

For more detailed descriptions of the transceiver unit 110 and the processing unit 120, refer to related descriptions in the foregoing method embodiments. Details are not described herein again.

FIG. 7 is a block diagram of a computing power capability sensing apparatus 200 according to an embodiment of this disclosure. As shown in the figure, the apparatus 200 includes at least one processor 220. The processor 220 is coupled to a storage, and is configured to execute instructions stored in the storage, to transmit a signal and/or receive a signal. Optionally, the apparatus 200 further includes a storage 230, configured to store instructions. Optionally, the apparatus 200 further includes a transceiver 210, and the processor 220 controls the transceiver 210 to transmit a signal and/or receive a signal.

It should be understood that the processor 220 and the storage 230 may be integrated into one processing device. The processor 220 is configured to execute program code stored in the storage 230 to implement the foregoing functions. During implementation, the storage 230 may alternatively be integrated into the processor 220, or may be independent of the processor 220.

It should be further understood that the transceiver 210 may include a transceiver (or referred to as a receiver machine) and a transmitter (or referred to as a transmitter machine). The transceiver may further include one or more antennas. The transceiver 210 may be a communication interface or an interface circuit.

In one embodiment, the transceiver 210 in the apparatus 200 may correspond to the transceiver unit 110 in the apparatus 100, and the processor 220 in the apparatus 200 may correspond to the processing unit 120 in the apparatus 100.

In a solution, the apparatus 200 is configured to implement operations performed by the terminal device or the radio access network device in the foregoing method embodiments.

For example, the processor 220 is configured to execute a computer program or the instructions stored in the storage 230, to implement related operations of the terminal device in the foregoing method embodiments, for example, the method 400 and the method 500.

In another solution, the apparatus 200 is configured to implement operations performed by the network device (for example, a radio access network device or a CMF network element) in the foregoing method embodiments.

For example, the processor 220 is configured to execute a computer program or the instructions stored in the storage 230, to implement related operations of the network device in the foregoing method embodiments, for example, the method 400 and the method 500.

It should be understood that a process in which the transceiver and the processor perform the foregoing corresponding operations is described in detail in the method embodiments. For brevity, details are not described herein again.

In an implementation process, the operations in the foregoing methods may be completed by using an integrated logic circuit of hardware in the processor, or instructions in a form of software. The operations in the methods disclosed with reference to embodiments of this disclosure may be directly performed and completed by a hardware processor, or may be performed and completed by using a combination of hardware in the processor and a software module. The software module may be located in a mature storage medium in the art, such as a random access storage, a flash storage, a read-only storage, a programmable read-only storage, an electrically erasable programmable storage, or a register. The storage medium is located in the storage, and the processor reads information in the storage and completes the operations in the foregoing methods in combination with hardware of the processor. To avoid repetition, details are not described herein again.

It should be noted that, the processor in embodiments of this disclosure may be an integrated circuit chip, and has a signal processing capability. In an implementation process, operations in the foregoing method embodiments may be completed by using an integrated logic circuit of hardware in the processor, or instructions in a form of software. The processor may be a general-purpose processor, a digital signal processor (DSP), an application-specific integrated circuit (ASIC), an FPGA or another programmable logic device, a discrete gate or transistor logic device, or a discrete hardware component. The methods, the operations, and logical block diagrams that are disclosed in embodiments of this disclosure may be implemented or performed. The general-purpose processor may be a microprocessor, or the processor may be any conventional processor or the like. The operations in the methods disclosed with reference to embodiments of this disclosure may be directly performed and completed by a hardware decoding processor, or may be performed and completed by using a combination of hardware in a decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the operations in the foregoing methods in combination with hardware of the processor.

It may be understood that the memory in embodiments of this disclosure may be a volatile memory or a non-volatile memory, or may include a volatile memory and a non-volatile memory. The non-volatile memory may be a read-only memory (read-only memory, ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of illustrative rather than limitative descriptions, many forms of RAMs are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory in the systems and methods described in this specification includes but is not limited to these memories and any memory of another proper type.

According to the methods provided in embodiments of this disclosure, this disclosure further provides a computer program product. The computer program product stores computer program code. When the computer program code is run on a computer, the computer is enabled to perform the methods performed by the terminal device and the radio access network device in any one of embodiments of the method 400 and the method 500.

According to the methods provided in embodiments of this disclosure, this disclosure further provides a computer program product. The computer program product stores computer program code. When the computer program code is run on a computer, the computer is enabled to perform the methods performed by the network device (for example, a radio access network device or a CMF network element) in any one of embodiments of the method 400 and the method 500.

According to the methods provided in embodiments of this disclosure, this disclosure further provides a computer-readable medium. The computer-readable medium stores program code. When the program code is run on a computer, the computer is enabled to perform the methods performed by the terminal device or the radio access network device in any one of embodiments of the method 400 and the method 500.

According to the methods provided in embodiments of this disclosure, this disclosure further provides a computer-readable medium. The computer-readable medium stores program code. When the program code is run on a computer, the computer is enabled to perform the methods performed by the network device (for example, a radio access network device or a CMF network element) in any one of embodiments of the method 400 and the method 500.

For explanations and beneficial effects of related content in any one of the foregoing provided apparatuses, refer to the corresponding method embodiments provided above. Details are not described herein again.

All or some of the foregoing embodiments may be implemented by using software, hardware, firmware, or any combination thereof. When software is used to implement embodiments, all or a part of embodiments may be implemented in a form of a computer program product. The computer program product includes one or more computer instructions. When the computer instructions are loaded and executed on a computer, procedures or functions according to embodiments of this disclosure are all or partially generated. The computer may be a general-purpose computer, a special-purpose computer, a computer network, or another programmable device. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium that can be accessed by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

In the foregoing apparatus embodiments, a corresponding module or unit performs a corresponding operation. For example, a transceiver unit (transceiver) performs a receiving operation or a sending operation in the method embodiments, and a processing unit (processor) may perform operations other than the sending operation and the receiving operation. For a function of a particular unit, refer to a corresponding method embodiment. There may be one or more processors.

The terms such as “component”, “module”, and “system” used in this specification are used to represent computer-related entities, hardware, firmware, combinations of hardware and software, software, or software being executed. For example, the component may be, but is not limited to, a process that runs on a processor, a processor, an object, an executable file, an execution thread, a program, and/or a computer. As illustrated by using figures, both a computing device and an application that runs on the computing device may be components. One or more components may reside in the process and/or the execution thread, and the components may be located on one computer and/or distributed between two or more computers. In addition, these components may be executed from various computer-readable media that store various data structures. The components may, for example, perform communication by using a local and/or remote process and based on a signal having one or more data packets (for example, data from two components interacting with another component in a local system, a distributed system, and/or across a network such as the Internet interacting with another system by using the signal).

A person of ordinary skill in the art may be aware that, in combination with the examples described in embodiments disclosed in this specification, units and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for a purpose of convenient and brief descriptions, for a detailed working process of the foregoing system, device, and unit, refer to a corresponding process in the foregoing method embodiments. Details are not described herein again.

In the several embodiments provided in this disclosure, it should be understood that the disclosed system, device, and method may be implemented in another manner. For example, the described device embodiment is merely an example. For example, unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the devices or units may be implemented in electronic, mechanical, or another form.

The units described as separate components may or may not be physically separate, and components displayed as units may or may not be physical units, may be located in one position, or may be distributed on a plurality of network units. Some or all of the units may be selected based on an actual requirement to achieve the objectives of the solutions of embodiments.

In addition, functional units in embodiments of this disclosure may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this disclosure essentially, or the part contributing to the conventional technology, or a part of the technical solutions may be implemented in a form of a software product. The computer software product is stored in a storage medium, and includes several instructions for instructing a computer device (which may be a personal computer, a server, a network device, or the like) to perform all or a part of the operations of the methods described in embodiments of this disclosure. The storage medium includes any medium that can store program code, such as a USB flash drive, a removable hard disk, a read-only memory (ROM), a random access memory (RAM), a magnetic disk, or an optical disc.

The foregoing descriptions are merely implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A method, applicable to a first apparatus, the method comprising:
receiving first signaling from a second apparatus indicating one or more of a type of a computing power capability that the first apparatus is to report or a granularity of the computing power capability that the first apparatus is to report; and
reporting the computing power capability to the second apparatus based on the first signaling.

2. The method according to claim 1, wherein the type of the computing power capability comprises at least one of:
a processor of the first apparatus, storage space of the first apparatus, a memory of the first apparatus, or a state of charge of the first apparatus.

3. The method according to claim 2, wherein the granularity of the computing power capability comprises at least one of:
a granularity of the processor reported by the first apparatus, a granularity of the storage space reported by the first apparatus, a granularity of the memory reported by the first apparatus, or a granularity of the state of charge reported by the first apparatus.

4. The method according to claim 1, further comprising:
receiving second signaling from the second apparatus comprising identification information that identifies a computing power resource, wherein the second signaling indicates the first apparatus to report a usage status of the computing power resource corresponding to the computing power capability of the first apparatus; and
sending third signaling to the second apparatus comprising information about the usage status of the computing power resource.

5. The method according to claim 4, wherein the usage status of the computing power resource comprises at least one of: a utilization ratio of the computing power resource, the computing power resource being idle, and the computing power resource being occupied.

6. The method according to claim 4, wherein the identification information comprises at least one of:
identification information of resource configuration, or
index information of the resource configuration.

7. The method according to claim 4, further comprising:
periodically sending the third signaling to the second apparatus; or
sending the third signaling to the second apparatus when the utilization ratio of the computing power resource exceeds a configured threshold.

8. The method according to claim 4, wherein the third signaling is any one of: layer 1 (L1) signaling, layer 2 (L2) signaling, layer 3 (L3) signaling, long media access control-control element signaling, or short media access control-control element signaling.

9. A method, applicable to a second apparatus, the method comprising:
sending, first signaling to a first apparatus indicating one or more of a type of a computing power capability that the first apparatus is to report, or a granularity of the computing power capability that the first apparatus is to report; and
receiving the computing power capability reported by the first apparatus.

10. The method according to claim 9, wherein the type of the computing power capability comprises at least one of:
a processor of the first apparatus, storage space of the first apparatus, a memory of the first apparatus, or a state of charge of the first apparatus.

11. The method according to claim 10, wherein the granularity of the computing power capability comprises at least one of:
a granularity of the processor reported by the first apparatus, a granularity of the storage space reported by the first apparatus, a granularity of the memory reported by the first apparatus, or a granularity of the state of charge reported by the first apparatus.

12. The method according to claim 9, further comprising:
sending second signaling to the first apparatus comprising identification information that identifies a computing power resource, wherein the second signaling indicates the first apparatus to report a usage status of the computing power resource corresponding to the computing power capability of the first apparatus; and
receiving third signaling from the first apparatus comprising information about the usage status of the computing power resource.

13. The method according to claim 12, wherein the usage status of the computing power resource comprises at least one: a utilization ratio of the computing power resource, the computing power resource being idle, and the computing power resource being occupied.

14. The method according to claim 12, wherein the identification information comprises at least one of identification information of resource configuration or index information of the resource configuration.

15. The method according to claim 12, further comprising one of:
periodically receiving the third signaling from the first apparatus; or
receiving the third signaling from the first apparatus when the utilization ratio of the computing power resource exceeds a configured threshold.

16. The method according to claim 12, wherein the third signaling is any one of: layer 1 (L1) signaling, layer 2 (L2) signaling, layer 3 (L3) signaling, long media access control-control element signaling, or short media access control-control element signaling.

17. A first apparatus, comprising:
a processing circuit; and
a communication interface,
wherein the communication interface is configured to receive first signaling from a second apparatus indicating one or more of a type of a computing power capability that the first apparatus is to report or a granularity of the computing power capability that the first apparatus is to report; and
the processing circuit is configured to report the computing power capability to the second apparatus based on the first signaling.

18. The first apparatus according to claim 17, wherein the type of the computing power capability comprises at least one of:
a processor of the first apparatus, storage space of the first apparatus, a memory of the first apparatus, or a state of charge of the first apparatus.

19. The first apparatus according to claim 18, wherein the granularity of the computing power capability comprises at least one of:
a granularity of the processor reported by the first apparatus, a granularity of the storage space reported by the first apparatus, a granularity of the memory reported by the first apparatus, or a granularity of the state of charge reported by the first apparatus.

20. The first apparatus according to claim 17, wherein the processing circuit is further configured to:
receive second signaling from the second apparatus comprising identification information that identifies a computing power resource, wherein the second signaling indicates the first apparatus to report a usage status of the computing power resource corresponding to the computing power capability of the first apparatus; and
send third signaling to the second apparatus comprising information about the usage status of the computing power resource.
